(19) United States
(12) Patent Application Publication
(10) Pub. No.: US 2022/0005110 A1
(43) Pub. Date: Jan. 6, 2022

(54) UNIFIED SEARCH TOOL FOR AN APPLICATION USER INTERFACE

(71) Applicant: Uber Technologies, Inc., San Francisco, CA (US)

(72) Inventors: Andrew Martin Warr, San Francisco, CA (US); Joost van der Ree, San Francisco, CA (US); Ryan Yu, San Francisco, CA (US); Wesley KaiJie Leung, San Francisco, CA (US)

(21) Appl. No.: 16/918,642

(22) Filed: Jul. 1, 2020

(51) Int. Cl. G06Q 30/06; G06Q 50/12; G06Q 50/30; G06F 16/9535; G06F 16/9537

(52) U.S. Cl. CPC G06Q 30/0643; G06Q 50/12; G06F 16/9537; G06F 16/9535; G06Q 50/30

(57) ABSTRACT

A system can receive input data from an application running on a computing device of a requesting user. The input data can correspond to a set of alphanumeric characters provided in a search box presented on a user interface of the application. In response to receiving the input data, the system can execute a federated search by providing search data corresponding to the set of alphanumeric characters to multiple search engines operated by the computing system, each search engine pertaining to a specific service option of multiple service options that are accessible via the application. The system can obtain and process search results from the multiple search engines based on the search data in accordance with a unification protocol to generate a unified search result. The system may then transmit data enabling the application to present a selectable user interface feature for each result of the unified search result.

### BACKGROUND

Typical transport arrangement services provide a destination search feature as part of an application user interface to allow a user to input a destination for the transport service. A computing system is tasked to determine a transport provider for that user upon receiving the desired destination. As on-demand services continue increasing in prevalence, user interface features of the service application continue to adapt for increased convenience and user engagement.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example computing system implementing unified search for users of an application-based service, in accordance with examples described herein;

FIG. 2 is a block diagram illustrating an example computing device executing one or more service applications for communicating with a computing system, according to examples described herein;

FIGS. 3A through 3D are screenshots of example user interfaces of showing the user experience in engaging with an application-based service, according to various examples;

FIGS. 4A through 4C are flow charts describing example methods of executing dynamic unified searches and facilitating service requests for users of an application-based service, according to various examples; and

FIG. 5 is a block diagram that illustrates a computer system upon which examples described herein may be implemented.

### DETAILED DESCRIPTION

A computing system can communicate with computing devices of users of an application-based service, such as a combined service system that facilitates rideshare, goods delivery, food preparation, bikeshare, scooter-share, and like services. In various implementations, the user interface of the application-based service can include a search box or search input feature with omni-search functions having an underlying service focus (e.g., an omni-search box). For example, typical search platforms perform searches by employing a web search engine that bases search results on a priority rank system, in which an indexing infrastructure outputs the results typically based on word relevance. According to examples provided herein, the computing system can facilitate an omni-search function through the user interface of the service application by expanding the destination search function of previous implementations to include real-time results for (i) transport relevant locations—such as restaurants, boutiques, grocery stores, gyms, and the like—as well as (ii) the on-demand service options themselves—such as rideshare, food delivery, grocery delivery, freight transport, package delivery, prescription pickup and/or delivery, bikeshare, scooter-share, transit connection, and the like.

Accordingly, the real-time results can comprise multi-modal results specific to particular locations and the relevant on-demand or scheduled services offered through the user interface of the service application. In some implementations, the system can use contextual and/or historical information of the user (and/or a pool of other users) to determine or predict the user's intent or interest when the user inputs a search query. As an example, an omni-search box can be provided on a home screen of the user interface of the service application. If the user wants to order coffee for pickup or delivery from a local coffee shop, the user may begin typing “coffee” into the omni-search box. The computing system can receive input data corresponding to each typed character as the character is provided by the user in the service application (e.g., in real-time) and can perform a search and provide results using the received input data (e.g., provide real-time multi-modal/search results). Accordingly, while the user is typing, a ranked set or list of location and/or service results can be displayed on the service application, which provide selectable links to the specific services facilitated by the on-demand service application. In the coffee example, a returned result can include an on-demand coffee ordering feature for a specific coffee house location within a certain proximity of the user's current location. In further examples, the ordering feature can include a delivery option or a pickup option, enabling the user to readily make a selection and request the desired service option. Alternatively, the user can be provided an option to request a transport service to one or more establishments that provide coffee.

Depending on implementation, on the user interface side, the search results can become more narrowly tailored in terms of both the location and service option as the user provides alphanumeric characters in the search box. In addition to the search box, the user interface can be arranged with service-specific tiles that, when selected, function to filter a subsequent search typed into the search box. For example, a home screen of the transport service application can include several selectable service-specific tiles, such as a rideshare tile, a food delivery and/or pickup tile, a grocery delivery tile, a prescription delivery tile, and/or a transit connector tile. If the user wishes to order coffee for pickup, the user may initially select the food delivery and/or pickup tile, resulting in a service constraint for the subsequent search. Thus, when the user begins typing in the search box, the returned results are only relevant to locations at which comestible goods can be prepared for pickup and/or delivery.

In further implementations, the search box can provide real-time multi-modal results based on general historical information of user engagement of the transport services and current contextual information (e.g., time of the day, day of the week, weather conditions, etc.). For example, on a weekday morning, the backend computing system can take into account that many users order coffee in the morning, and can apply an increased weighting value or score to coffee-related results in order to dynamically modify the order or ranking in which a set of results are generated for transmission to and display on the user's device, particularly when the relevant alphanumeric characters are inputted (e.g., “c” and “o,” or the first few letters of a popular coffee house).

In still further implementations, the search box can provide personalized search results specific to each user's historical engagement with the transport service application. Accordingly, the computing system can account for historical user information in connection with the transport services, such as, for example, which services the user typically utilizes or have utilized in a past duration of time, any common destinations, pickup or destination locations (e.g., for order pickups or for traveling to a location), or delivery service sources (e.g., restaurants or grocery stores), in order to provide more personalized, real-time search results. Furthermore, it is contemplated that the search box can further be linked to voice inputs (e.g., triggered by a voice activation button), which can return the multi-modal results.

As provided herein, the backend computing system can employ federated information retrieval in real-time to implement each search and return results. In doing so, the computing system can distribute each query or partial query to multiple search engines and/or databases operated by the computing system (e.g., specific to the various transport, delivery, and/or food preparation services provided by the service application) and process or merge the search results in accordance with a unification protocol specific to the service application and the various transport service options provided. Accordingly, in the search query and/or merging process, the computing system can implement various contextual filters, priority weightings, and/or location-based filters (e.g., centered on the user's current location) in generating the results.

In further implementations, the computing system can generate selectable and interactive user interface features for presentation on the user's computing device that comprise a unified search result that enables the user to readily request a desired service option. In certain examples, the unified search result can be multi-modal, facilitating multiple requestable service options. For example, if a restaurant is selected, the user may wish to order delivery from the restaurant, order takeout from the restaurant, and/or request to be transported to the restaurant. In examples described herein, a selectable user interface feature may be presented in the unified search results that enable the user to request any one or more of the relevant service options.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method.

Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

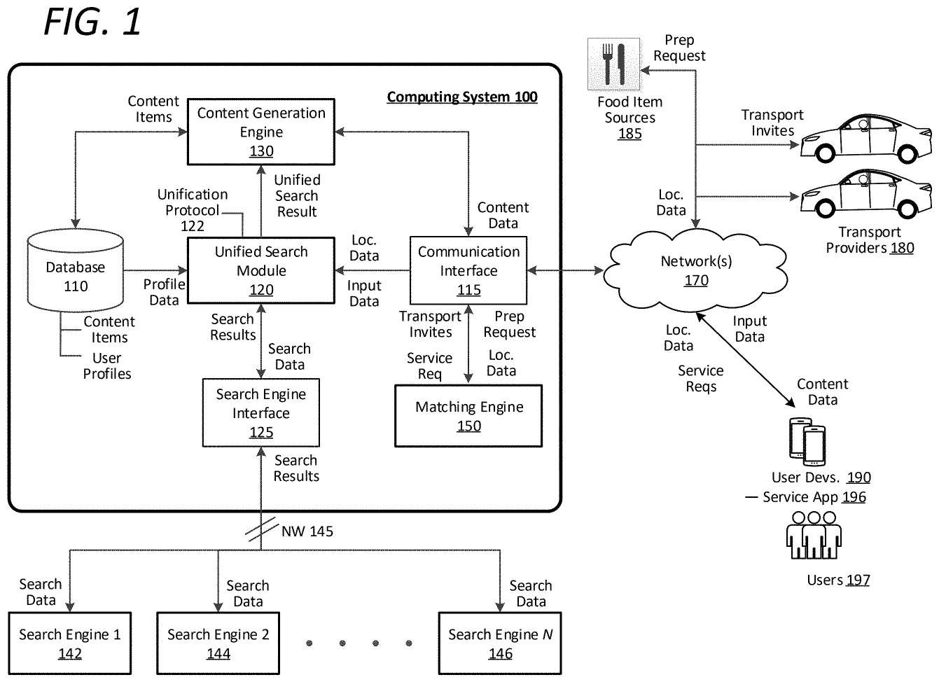

FIG. 1 is a block diagram illustrating an example computing system implementing unified search for users of an application-based service, in accordance with examples described herein. In various implementations, the computing system 100 can include a communication interface 115 that enables the computing system 100 to communicate, over one or more networks 170 with computing devices 190 of users 197 of an application-based service. According to examples provided herein, the application-based service can involve on-demand transport services, such as a set of rideshare services, food preparation and delivery and/or package delivery, a bikeshare service, a scooter-share service, and the like. In certain examples, each of the foregoing service options may be accessed via a user interface of an executing service application 196 on the computing device 190 of the user 197.

In various implementations, the computing system 100 can further communicate, over the network(s) 170 with computing devices of transport providers 180, which can comprise delivery drivers, rideshare drivers, autonomous vehicles, and the like. In further implementations, the computing system 100 can communicate, over the network(s) 170 with computing devices of food item sources 185, such as restaurants providing delivery and takeout services, and additional on-demand service providers, such as pharmacies, grocery stores, etc. In general, the computing system 100 can include a matching engine 150 that receives location data from the users 197 and transport providers 180, and further receives transport requests or service requests from the users 197. Upon receiving a transport or service request from a requesting user 197, the matching engine 150 can select an optimal transport provider 180 to fulfill the request based on distance, time, estimated arrival time, and various other matching metrics that enable the selected transport provider 180 to provide the requested service for the user 197 (e.g., a type of vehicle driven, on-board inventory, etc.).

The computing system 100 can further include a unified search module 120 that communicates over one or more networks 145 with a set of search engines 142, 144, 146 of the application-based service. In certain examples, the computing system 100 can operate or communicate with dedicated search engines 142, 144, 146 of the application-based service. For example, the application-based service can comprise a plurality of service options, as mentioned above, with each service option operating a dedicated search engine. In the example shown in FIG. 1, search engine 1 142 can correspond to a first service option, such as a rideshare service option. Search engine 2 144 can correspond to a second service option, such as a food pickup and/or delivery option. And, search engine N 146 can correspond to an nth service option of the application-based service, which can correspond to, say, a bikeshare service option.

As provided herein, each search engine 142, 144, 146 of each service option can be confined to searches that are only relevant to its corresponding search option. Accordingly, for search engine N 146 corresponding to a bikeshare service option, the search engine N 146 can operate to search for available bikes in a given region (e.g., within a certain proximity of the requesting user 197). As another example, search engine 2 144, corresponding to food preparation and delivery, can be confined to searches related to restaurants that are partnered with the application-based service for food pickup or delivery.

In previous implementations, the user 197 would manually engage the user interface of the service application 196 to select a particular service option. For example, upon selecting a food delivery service option, a list of restaurant partners can be displayed to the user 197 (e.g., within a five-mile radius of the user 197. The food delivery service interface may then be presented on the user interface of the service application 196 to enable the user 197 to browse food delivery options and menus of individual restaurant partners. The food delivery service interface can also include a search box, in which the user may type a set of alphanumeric characters, and the dedicated search engine 2 144 for the food delivery service option can execute a real-time service based on the typed inputs by the user 197.

Also, in previous implementations, the user 197 may select a rideshare option on a main page of the user interface of the service application 196. This selection can trigger a rideshare service interface to be displayed, enabling the user to input a destination and select a rideshare service option (e.g., luxury car, standard rideshare, pooled rideshare, high-capacity vehicle, etc.) to configure and transmit a ride request. The rideshare service interface can also include search box (e.g., enabling the user 197 to type in a destination, and a map interface indicated the locations of proximate available drivers. Accordingly, once in the rideshare service interface, the search engine 1 142 dedicated for rideshare searches can perform real-time searches for available drivers and destinations based on each alphanumeric character that the user 197 inputs into the destination search box.

Thus, the dedicated search engines 142, 144, 146 for each service option have previously been triggered to perform searches after the user 197 has selected a particular service option. According to examples provided herein, the computing system 100 can include a search engine interface 125 that provides real-time access for the unified search module 120 to each of the dedicated search engines 142, 144, 146 for each service option. The computing system 100 can further include a content generation engine 130 that transmits content data to the computing devices 190 of the users 197 via the service application 196. In certain examples, upon launching the service application 196, the content generation engine 130 can cause a unified user interface to be displayed on the computing device 190 of the user 197.

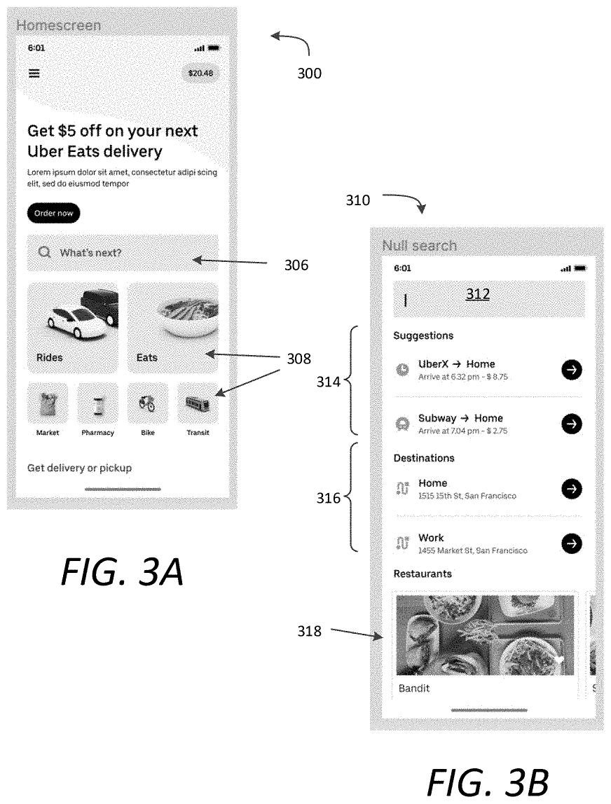

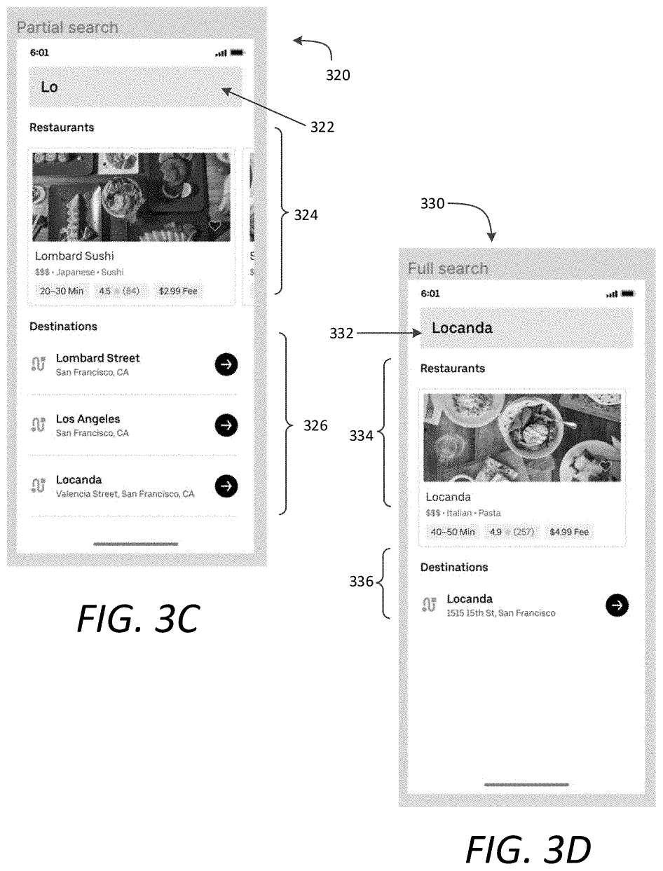

In many aspects, the computing system 100 can also include a database 110 storing user profiles of the users 197 of the application-based service. The user profiles can include historical utilization data indicating the service option(s) with which the user 197 commonly engages, how often the user 197 engages with each service option, timestamps, and contextual information regarding individual service requests (e.g., time of day, day of the week, weather conditions, pickup and/or drop-off locations, commonly ordered food items, favorite restaurants, service preferences, and the like). As described below with respect to FIGS. 3A through 3D, the content generation engine 130 can perform a lookup in the database 110 for the user profile of the user 197 upon executing of the service application 196, and provide a custom arrangement of selectable tiles or icons representing each service option in accordance with the most commonly utilized service options. In such examples, the most commonly utilized service options by the user 197 can be more prominently presented on the user interface than other less commonly utilized options.

In variations, the home screen of the user interface may be universal for all users 197 of the application-based service, and can prominently display the icons or tiles representing the most commonly utilized service options in general, such as rideshare and food pickup or delivery. The home screen of the service application 196 can further include a unified search box, which is not dedicated to any single service option provided via the service application 196. According to examples provided herein, the user 197 can input alphanumeric characters into the unified search box, which can cause the unified search module 120 to receive input data corresponding to the user's 197 inputs. In real time, the unified search module 120 can generate search data for the search engines 142, 144, 146 to each perform searches of their dedicated service options. In various examples, this live unified search can be performed in response to each alphanumeric character typed by the user 197.

In performing the live unified search, the unified search module 120 can employ federated information retrieval in real time to implement each search and return a unified search result. Specifically, the unified search module 120 can distribute each query or partial query comprised of the input data to the multiple search engines 142, 144, 146 and/or database(s) 110 operated by the computing system (e.g., specific to the various transport, delivery, and/or food preparation services provided through the service application 196) and process or merge the search results in accordance with a unification protocol 122 specific to the service application 196 and the various transport service options provided. In the search query and/or merging process, the unified search module 120 can implement various contextual filters, priority weightings, and/or location-based filters (e.g., centered on the user's current location) in generating the unified search result.

In certain implementations, the unified search can be individually tailored for the user 197 based on the user's 197 profile data. In such an example, the unified search module 120 can access the profile data of the user 197 in the database 110, and utilize the profile data as a filtering tool to filter out any irrelevant or unutilized service options in the search results from the search engines 142, 144, 146. Accordingly, the unified search module 120 can receive the search results from the search engines 142, 144, 146 over the network 145 and can generate a unified search result based on the unification protocol 122 and/or the profile data of the user 197. It is contemplated that the unified search process performed by the unified search module 120 can be performed in response to each alphanumeric character typed into a search box of the user interface by the user 197.

According to examples provided herein, the search box can facilitate an omni-search function through the user interface of the service application 196 by expanding a previously used destination search function to include real-time results from the search engines 142, 144, 146 for (i) transport relevant locations—such as restaurants, boutiques, grocery stores, gyms, and the like—as well as (ii) the on-demand service options themselves—such as rideshare, food delivery, grocery delivery, freight transport, package delivery, prescription pickup and/or delivery, bikeshare, scooter-share, transit connection, and the like. The unification protocol 122 utilized by the unified search module 120 can comprise a prioritization scheme based on the most popular service options and/or locations within a given region, and/or based on the profile data of the user 197 to provide a personalized unified search result.

Accordingly, the unified search result from the unified search module 120 can comprise multi-modal results specific to particular locations and the relevant on-demand or scheduled services offered through the user interface of the service application 196. As an example, the search box can be provided on a home screen of the user interface of the service application 196. Instead of the search box querying for a destination, the search box can generally query for what the user wishes to do next. If the user wants to pre-order a meal for delivery from a local restaurant, the user may begin typing the name of the restaurant into the search box. The unified search module 120 can receive input data corresponding to each typed character in real time, transmit search data corresponding to the user's inputs to the search engines 142, 144, 146, receive real time search results from the search engines 142, 144, 146, and can generate a real-time unified search result.

In various implementations, the real-time, unified search result can be processed by a content generation engine 130 that can generate content items, such as interactive service option features for multiple service options, for display on the user interface of the service application 196. The content generation engine 130 can generate the content data corresponding to the unified search result in real time as well, to enable the user 197 to view the interactive user interface features while typing. If a pertinent interactive user interface feature is presented (e.g., a service feature that enables the user to view a menu of a desired restaurant and configure an order for pickup or delivery), the user 197 may select the interactive feature to access the desired service option of the application-based service. Accordingly, while the user 197 is typing, a ranked list of location and service results can provide selectable links to the specific service options facilitated by the service application 196. In the restaurant example above, a returned result can include an on-demand food ordering feature for a specific restaurant location within a certain proximity of the user's current location. In further examples, the ordering feature can include a delivery option or a pickup option, enabling the user 197 to readily make a selection and request the desired service option (e.g., on-demand food delivery).

On the user interface side, the real-time search results can become more narrowly tailored in terms of both the location and service option as the user 197 provides alphanumeric characters in the search box. In addition to the search box, the user interface can be arranged with service-specific icons or tiles that, when selected, function to filter a subsequent search typed into the search box. For example, a home screen of the service application 196 can include several selectable service-specific icons or tiles, such as a rideshare tile, a food delivery and/or pickup tile, a grocery delivery tile, a prescription delivery tile, and/or a transit connector tile. If the user 197 wishes to order food for pickup, the user 197 may initially select the food delivery and/or pickup tile, resulting in a service constraint for the subsequent search by the unified search module 120. Thus, when the user 197 begins typing in the search box with the service option constraint in place, the returned results are only relevant to locations at which comestible goods can be prepared for pickup and/or delivery.

The user 197 may engage with the selectable content features generated by the content generation engine 130 in real time and displayed on the user interface of the service application 196 at any time to submit a desired service request (e.g., a ride request, food delivery request, etc.). As described herein the computing system 100 can include a matching engine 150 that processes service requests from the users 197 and facilitates the on-demand service option requested. For example, when the service request comprises a transport request, the matching engine 150 can determine a matching transport provider 180 based on distance, time, and various other metrics to rendezvous with the user 197 (e.g., to make a delivery or pick up the user 197 for transport to a desired destination). As another example, if the service request comprises a food pickup or delivery request, the matching engine 150 can transmit a food item preparation request to the pertinent food item source 185, and if applicable, transmit a transport request to a transport provider 180 to deliver the item(s) to the user 197.

Computing Device

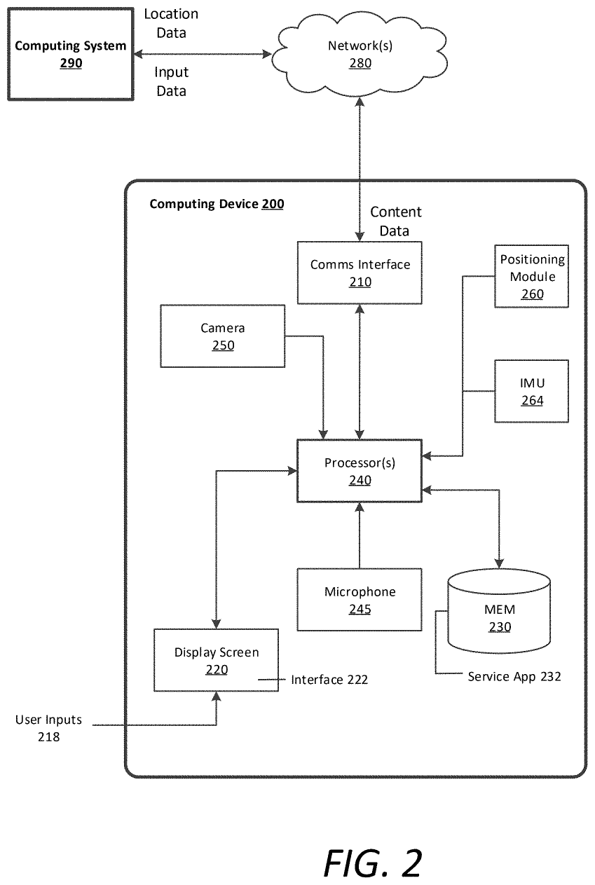

FIG. 2 is a block diagram illustrating an example computing device 200 executing a service application for communicating with a computing system 290, according to examples described herein. In various implementations, the computing device 200 can comprise a mobile computing device, such as a smartphone, tablet computer, laptop computer, VR or AR headset device, and the like. As such, the computing device 200 can include telephony features such as a microphone 245, a camera 250, and a communication interface 210 to communicate with external entities using any number of wireless communication protocols. The computing device 200 can further include a positioning module 260 (e.g., GPS) and an inertial measurement unit 264 that includes one or more accelerometers, gyroscopes, or magnetometers. In certain aspects, the computing device 200 can store a designated on-demand service application 232 in a memory 230. In variations, the memory 230 can store additional applications executable by one or more processors 240 of the computing device 200, enabling access and interaction with one or more host servers over one or more networks 280.

The computing device 200 can be operated by a requesting user 197 through execution of the on-demand service application 232. The computing device 200 can further be operated by a transport provider 190 through execution of a provider application. For requesting user 197 implementations, the user can select the service application 232 via a user input on the display screen 220, which can cause the service application 232 to be executed by the processor 240. In response, a user application interface 222 can be generated on the display screen 220, which can display available service options and enable the user to configure and submit a service request for a service provider to fulfill a request (e.g., to transport the user 197 to a destination).

As provided herein, the service application 232 can enable a communication link with a computing system 290 over one or more networks 280, such as the computing system 100 as shown and described with respect to FIG. 1. The processor 240 can generate user interface features using content data received from the computing system 290 over network 280. Furthermore, as discussed herein, the application 232 can enable the computing system 290 to cause the generated user interface 222 to be displayed on the display screen 220.

In various examples, the positioning module 260 can provide location data indicating the current location of the users and transport providers to the computing system 290 to, for example, enable the computing system 290 to coordinate on-demand transport, delivery, food preparation, and the like. In examples described herein, the computing system 290 can transmit content data to the communication interface 210 of the computing device 200 over the network(s) 280. The content data can cause the executing service application 232 to display the user interface 222 for the executing application 232. Upon selection of a desired transport or service option by a requesting user, the service application 232 can cause the processor 240 to transmit a service request to the computing system 290 to enable the computing system 290 to remotely coordinate and facilitate the various service options for the user 197 (e.g., match users with transport providers to facilitate on-demand transport).

According to examples described herein, when the requesting user 197 launches the service application 232, an initiation trigger is transmitted to the computing system 290, which causes the computing system 290 to present the user interface 222 as a set of service tiles each being selectable by the user to configure a service request, as described herein. Additionally, the home screen can include an search box that enables the user to type any set of alphanumeric characters. The computing system 290 can receive input data corresponding to the user's inputs, perform a unified search, and transmit content data to update the user interface 222 in real time, as further described herein.

Example User Interfaces

FIGS. 3A through 3D are screenshots of example user interfaces of showing the user experience in engaging with an application-based service, according to various examples. FIG. 3A shows an example home screen 300 of the service application. The home screen 300 can include a set of service tiles 308, which the user 197 can select at any time to execute a targeted, service-specific search and configure a service request accordingly. The home screen 300 can also include an search box 306 that is not service specific, but rather encompasses each search engine of the service options shown (e.g., rides, eats, market, pharmacy, bike, transit, etc.). As described herein, each service option can be associated with a dedicated search engine that performs searches specifically related to that particular service option. For example, the search engine for the pharmacy service option will be confined to return results relevant to pharmacy locations, prescription delivery services and the like.

According to examples provided herein, the user 197 can type anything into the search box 306, and input data corresponding to the user 197 typing can be transmitted in real time to the computing system 100, which can update the user interface accordingly. FIG. 3B is an example user interface 310 in which the user 197 has selected the search box 312, but has not yet typed anything. Upon selecting the search box 312, the backend computing system 100 can initially return results corresponding to the user's service utilization history. In the example shown in FIG. 3B, the computing system 100 can access the user profile of the user 197 and present interactive features corresponding to the user's commonly service options and/or destinations. In FIG. 3B, the user interface can display service options 314 to transport the user 197 home, the common destinations 316 of the user 197, and a recently utilized or commonly utilized restaurant 318 from which the user 197 ordered a meal via the service application 196.

FIG. 3C is an example user interface 320 in which the user 197 begins typing into the search box 322, thereby providing input data to the backend computing system 100. In the example shown in FIG. 3C, the user 197 has typed to letters “L” and “o” into the search box, which causes the computing system 100 to return real-time unified results based on the unification protocol 122, which can apply prioritizations and weightings to return the most relevant results for the user 197 across all the service options. A most relevant real-time result 324 can be displayed as a selectable, interactive service feature that enables the user 197 to configure a service request at any time during typing. In FIG. 3C, the most relevant result comprises a food delivery service option from the restaurant “Lombard Sushi,” which the user 197 can select to view the menu, select any number of food items for delivery or pickup, and place an order. The most relevant result 324 can also be laterally scrollable as shown in FIG. 3C to allow the user 197 to view additional results that satisfy the inputs provided in the search box 322.

The partial search interface 320 can further include other search results 326 that satisfy the input criteria entered by the user 197. In the example of FIG. 3C, each result 326 is selectable to configure a corresponding service option accordingly. For example, by typing a set of alphanumeric characters, the user's desired result may pop up on the user interface 320 at any given time, either in the most relevant 324 section, or the additional results section (in this case, indicating potential destinations satisfying the search criteria inputted by the user 197). As shown in FIGS. 3C and 3D, the result for the restaurant “Locanda” can be displayed in the results section 326 after the user 197 has typed two characters. The user 197 may stop typing at this stage and select the “Locanda” feature in the result section 326 of FIG. 3C to cause the full search interface 330 to be displayed, as shown in FIG. 3D.

Upon selection of the desired place of business in the results section 326 of FIG. 3C, the full search interface 330 of FIG. 3D can display the search box with the full name of the restaurant automatically inputted, and can provide the user 197 with available service options pertaining to the restaurant. As shown in FIG. 3D, these service options include an interactive feature 334 corresponding to a food order and/or delivery service option, and an interactive feature 336 corresponding to on-demand transport to the restaurant location. Thus, depending on whether the user 197 wishes to order food from the restaurant for pickup or delivery, or wishes to be transported to the restaurant, the user 197 can make the appropriate selection of either interface feature 334 or interface feature 336 to configure the service request.

Methodology

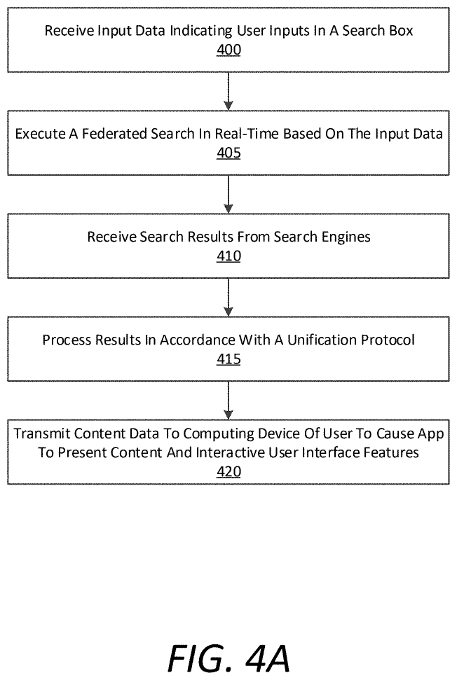

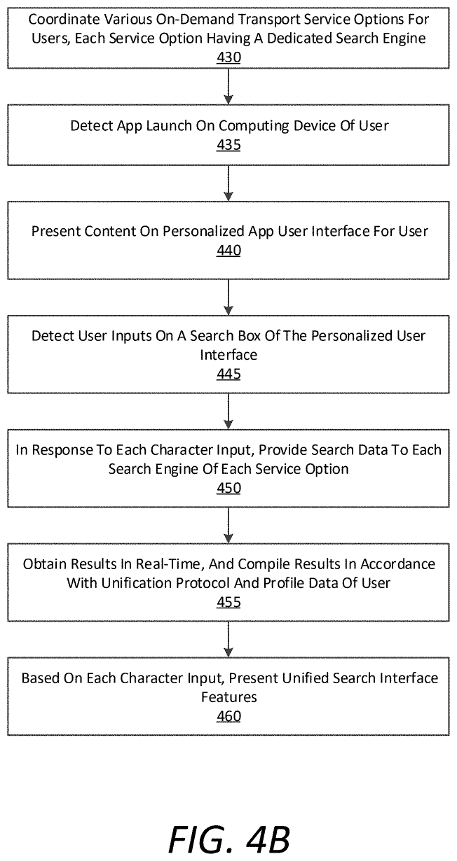

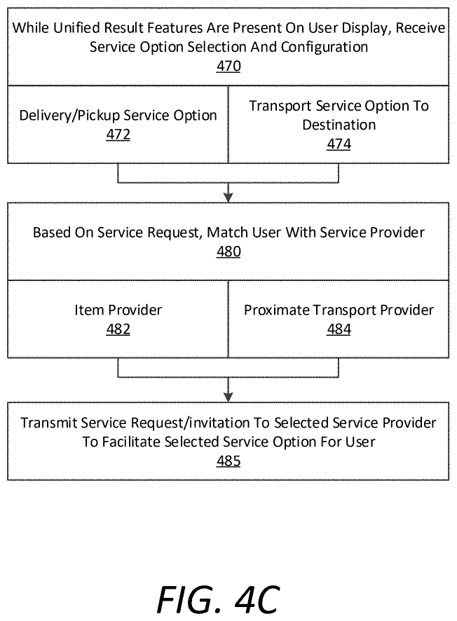

FIGS. 4A through 4C are flow charts describing example methods of executing a dynamic unified search for a user of an application-based service, according to various examples. In the below description of FIGS. 4A through 4C, reference may be made to reference characters representing like features as shown and described with respect to FIGS. 1, 2, and 3A through 3D. Furthermore, the processes described with respect to FIGS. 4A through 4C may be performed by an example computing system 100, 290 as shown as described with respect to FIGS. 1 and 2. Referring to FIG. 4A, the computing system 100 can receive input data indicating user inputs in a search box 306 displayed on a user interface 300 of a service application 196 (400). In various examples, the computing system 100 can execute a federated search in real-time based on the input data (405).

As described herein, each service option of the application-based service can comprise a dedicated search engine that automatically filters the search to yield search results that pertain to that specific service option. For example, a grocery delivery search option can return results of grocery store locations that offer delivery services. As another examples, a bike share search engine can return results pertaining to the locations of available bicycles within a certain proximity of the user's location. Thus, in performing the federate search, the computing system 100 can distribute search criteria corresponding to the input data to a plurality of search engines, with each search engine corresponding to a service option of the application-based service.

According to examples described herein, the computing system 100 can receive or obtain search results from the search engines in real-time (410). For example, the computing system 100 can distribute search criteria to the search engines in response to each alphanumeric character inputted by the user 197 into the search box 306, and each search engine can provide an updated search result accordingly. Based on the search results from the search engines, the computing system 100 can process the results in accordance with a unification protocol 122 (415). In doing so, the computing system 100 can determine which service option(s) and/or location(s) may be most relevant to the user's engagement with the service application 196. The computing system 100 may then generate content data and transmit the content data to the computing device 190 of the user 197 to cause the service application 196 to present the unified search result as a set of interactive user interface features that the user 197 can select in order to configure a desired service option (e.g., request a ride, order a food item, etc.) (420).

FIG. 4B is a flow chart describing an example method of executing a dynamic unified search that is personalized for the user 197, according to various examples. With reference to FIG. 4B, the computing system 100 can coordinate various on-demand service options for users 197 within a given region, with each service option having a dedicated search engine (430). In doing so, the computing system 100 can include a matching engine 150 that receives service requests from the users 197 and matches the users 197 to available transport providers 180 (e.g., delivery drivers, rideshare drivers, etc.), food item sources 185 (e.g., restaurants providing delivery or pickup services), pharmaceutical providers, grocery stores, and the like. In various examples, the computing system 100 can detect an application launch on the computing device 190 of a user 197 (435). In response, the computing system 100 can present content on a personalized application user interface 300 for the user 197 (440). For example, the computing system 100 can access profile data of the user 197 and determine a set of common destinations and/or historically utilized service options of the user 197 in the user's engagement with the application-based service. Based on the user's historical utilization of the application-based service, the computing system 100 can present a home screen 300 that is individually tailored for the user 197.

In various implementations, the computing system 100 can detect user inputs in a search box 306 of the user interface 300 (445). In response to each alphanumeric character input, the computing system 100 can transmit search data to each search engine of each service option (450). The computing system 100 may then obtain search results from the multiple search engines based on the search data in real time, and compile the results into a unified search result in accordance with a unification protocol 122 and/or the profile data of the user 197 (455). Based on each character input by the user 197 or a combination of multiple character inputs, the computing system 100 may then transmit data to the computing device 190 of the user 197 to present the unified search result as a set of interactive user interface features (460).

As described herein, the multiple service options can comprise a plurality of a rideshare option, a food delivery option, a food preparation option, a grocery delivery option, a freight transport option, a package delivery option, a prescription pickup and/or delivery option, a bikeshare option, a scooter-share option, or a transit connection option. as further described, the computing system 100 can provide the search data to each of the multiple search engines in response to each alphanumeric character provided in the search box by the requesting user 197. The computing system 100 can further obtain the search results from the multiple search engines and generate the unified search result for each inputted alphanumeric character provided in the search box.

In further implementation, the computing system can process the search results in accordance with the unification protocol 122 by ranking the search results from each of the multiple search engines based on user-specific information of the requesting user 197 (e.g., historical utilization data indicated in the user profile of the user 197). In still further implementations, the computing system 100 can detect, over the one or more networks, a user selection of a tile from a set of selectable tiles on the home screen of the user interface, where the selected tile corresponds to a selected service option of the multiple service options. Based on the selected service option, the computing system can filter the federated search to only provide results pertaining to the selected service option.

FIG. 4C is a flow chart describing an example method of coordinating an on-demand service for a user 197, according to examples provided herein. Referring to FIG. 4C, the computing system 100 can receive a service option selection and configuration while a set of interactive unified search result features are present on the user interface 300 of a service application 196 (470). As described herein, the selected service option can comprise a delivery and/or pickup service option, such as with food items from restaurants, groceries, pharmaceuticals, and the like (472), or a transport service option for transporting the user 197 to a destination (474).

In various examples, the computing system 100 can match the user with a service provider based on the service request (480). As such, the computing system 100 can match the user 197 is an item provider, such as a food item preparation source, grocery store, pharmacy, etc. (482), or a proximate transport provider 180 (484), depending on the service option selection. Thereafter, the computing system 100 can transmit a service request or transport invitation to the matched service provider to facilitate the selected service option for the user 197 (485). As described herein, the service request or invitation can comprise a food item request for pickup or delivery that the user 197 has configured via the service application 196, a grocery delivery request, a prescription order for delivery or pickup, or a transport option (e.g., bicycle, scooter, rideshare, etc.). Accordingly, the computing system 100 can facilitate any number of on-demand service options for the user 197.

Hardware Diagram

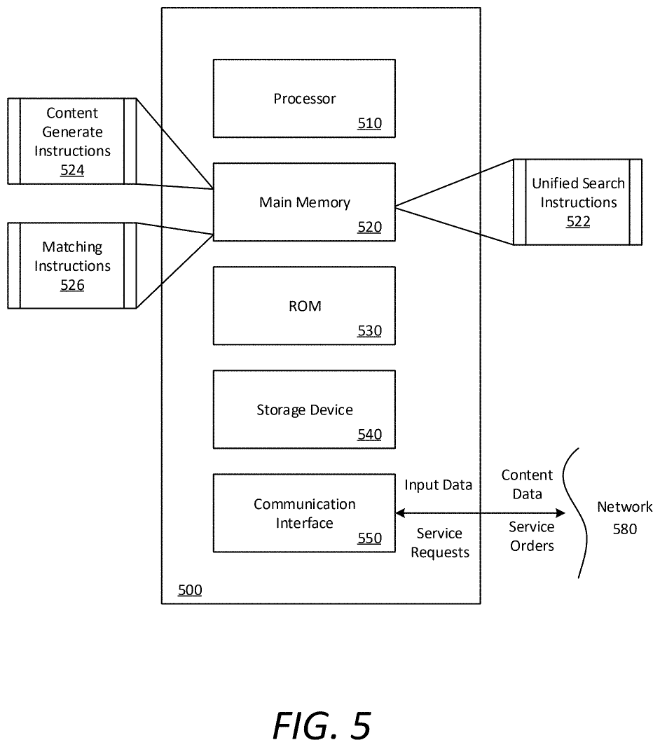

FIG. 5 is a block diagram that illustrates a computer system upon which examples described herein may be implemented. A computer system 500 can be implemented on, for example, a server or combination of servers. For example, the computer system 500 may be implemented as part of a network service, such as described in FIGS. 1 through 4. In the context of FIG. 1, the computer system 100 may be implemented using a computer system 500 such as described by FIG. 5. The computer system 100 may also be implemented using a combination of multiple computer systems as described in connection with FIG. 5.

In one implementation, the computer system 500 includes processing resources 510, a main memory 520, a read-only memory (ROM) 530, a storage device 540, and a communication interface 550. The computer system 500 includes at least one processor 510 for processing information stored in the main memory 520, such as provided by a random-access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions.

The communication interface 550 enables the computer system 500 to communicate with one or more networks 580 (e.g., cellular network) through use of the network link (wireless or wired). Using the network link, the computer system 500 can communicate with one or more computing devices, one or more servers, one or more databases, and/or one or more self-driving vehicles. In accordance with examples, the computer system 500 receives initiation triggers, location data, and requests from mobile computing devices of individual users. The executable instructions stored in the memory 530 can include unified search instructions 522 and content generating instructions 524, and matching instructions 526.

By way of example, the instructions and data stored in the memory 520 can be executed by the processor 510 to implement the functions of an example computing system 100 of FIG. 1. In various examples, the processor 510 can execute the unified search instructions 522 to receive input data corresponding to user inputs into an search box, provide search data to multiple search engines, obtain results from the search engines, and generate a unified search result based on a unification protocol, as described herein. The processor 510 can further execute the content generating instructions 524 to generate a set of interactive user interface features based on the unified search result and provide content data to the computing device of the user. The processor can further execute the matching instructions 526 to receive service requests from the users, and transmit service orders corresponding to the requests to matching service providers accordingly.

Examples described herein are related to the use of the computer system 500 for implementing the techniques described herein. According to one example, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A computing system comprising:
a network communication interface to communicate, over one or more networks, with computing devices of requesting users;
one or more processors; and
a memory storing instructions that, when executed by the one or more processors, cause the computing system to:
receive, over the one or more networks, input data from an application running on a computing device of a requesting user, the input data corresponding to a set of alphanumeric characters provided in a search box presented on a user interface of the application;
in response to receiving the input data, execute a federated search by providing search data corresponding to the set of alphanumeric characters to multiple search engines operated by the computing system, each search engine pertaining to a specific service option of multiple service options that are accessible via the application;
obtain search results from the multiple search engines based on the search data;
process the search results in accordance with a unification protocol to generate a unified search result; and
transmit, over the one or more networks, data corresponding to the unified search results to the computing device of the user, the data enabling the application to present a selectable user interface feature for each result of the unified search result, wherein each selectable user interface feature corresponds to one of the multiple service options.

2. The computing system of claim 1, wherein the multiple service options comprise a plurality of a rideshare option, a food delivery option, a food preparation option, a grocery delivery option, a freight transport option, a package delivery option, a prescription pickup and/or delivery option, a bikeshare option, a scooter-share option, or a transit connection option.

3. The computing system of claim 1, wherein the executed instructions cause the computing system to provide the search data to each of the multiple search engines in response to each alphanumeric character provided in the search box by the requesting user.

4. The computing system of claim 3, wherein the executed instructions cause the computing system to obtain the search results from the multiple search engines and generate the unified search result for each inputted alphanumeric character provided in the search box.

5. The computing system of claim 1, wherein executed instructions cause the computing system to process the search results in accordance with the unification protocol by ranking the search results from each of the multiple search engines based on user-specific information of the requesting user.

6. The computing system of claim 5, wherein the user-specific information corresponds to the requesting user's historical utilization of the multiple service options accessible via the application.

7. The computing system of claim 1, wherein the user interface of the application provides a home screen comprising the search box and a set of selectable tiles, each tile in the set of selectable tiles representing a corresponding service option of the multiple service options.

8. The computing system of claim 7, wherein the executed instructions further cause the computing system to:
prior to receiving the input data, detect, over the one or more networks a user selection of a tile from the set of selectable tiles, the selected tile corresponding to a selected service option of the multiple service options;
wherein the executed instructions cause the computing system to filter the federated search based the selected service option corresponding to the selected tile.

9. A non-transitory computer-readable medium storing instructions that, when executed by one or more processors of a computing system, cause the computing system to:
communicate, over one or more networks, with computing devices of requesting users;
receive, over the one or more networks, input data from an application running on a computing device of a requesting user, the input data corresponding to a set of alphanumeric characters provided in a search box presented on a user interface of the application;
in response to receiving the input data, execute a federated search by providing search data corresponding to the set of alphanumeric characters to multiple search engines operated by the computing system, each search engine pertaining to a specific service option of multiple service options that are accessible via the application;
obtain search results from the multiple search engines based on the search data;
process the search results in accordance with a unification protocol to generate a unified search result; and
transmit, over the one or more networks, data corresponding to the unified search results to the computing device of the user, the data enabling the application to present a selectable user interface feature for each result of the unified search result, wherein each selectable user interface feature corresponds to one of the multiple service options.

10. The non-transitory computer-readable medium of claim 9, wherein the multiple service options comprise a plurality of a rideshare option, a food delivery option, a food preparation option, a grocery delivery option, a freight transport option, a package delivery option, a prescription pickup and/or delivery option, a bikeshare option, a scooter-share option, or a transit connection option.

11. The non-transitory computer-readable medium of claim 9, wherein the executed instructions cause the computing system to provide the search data to each of the multiple search engines in response to each alphanumeric character provided in the search box by the requesting user.

12. The non-transitory computer-readable medium of claim 11, wherein the executed instructions cause the computing system to obtain the search results from the multiple search engines and generate the unified search result for each inputted alphanumeric character provided in the search box.

13. The non-transitory computer-readable medium of claim 9, wherein executed instructions cause the computing system to process the search results in accordance with the unification protocol by ranking the search results from each of the multiple search engines based on user-specific information of the requesting user.

14. The non-transitory computer-readable medium of claim 13, wherein the user-specific information corresponds to the requesting user's historical utilization of the multiple service options accessible via the application.

15. The non-transitory computer-readable medium of claim 9, wherein the user interface of the application provides a home screen comprising the search box and a set of selectable tiles, each tile in the set of selectable tiles representing a corresponding service option of the multiple service options.

16. The non-transitory computer-readable medium of claim 15, wherein the executed instructions further cause the computing system to:
prior to receiving the input data, detect, over the one or more networks a user selection of a tile from the set of selectable tiles, the selected tile corresponding to a selected service option of the multiple service options;
wherein the executed instructions cause the computing system to filter the federated search based the selected service option corresponding to the selected tile.

17. A computer-implemented method of facilitating user experience via an interactive user interface, the method being performed by one or more processors of a computing system and comprising:
communicating, over one or more networks, with computing devices of requesting users;
receiving, over the one or more networks, input data from an application running on a computing device of a requesting user, the input data corresponding to a set of alphanumeric characters provided in a search box presented on a user interface of the application;
in response to receiving the input data, executing a federated search by providing search data corresponding to the set of alphanumeric characters to multiple search engines operated by the computing system, each search engine pertaining to a specific service option of multiple service options that are accessible via the application;
obtaining search results from the multiple search engines based on the search data;
processing the search results in accordance with a unification protocol to generate a unified search result; and
transmitting, over the one or more networks, data corresponding to the unified search results to the computing device of the user, the data enabling the application to present a selectable user interface feature for each result of the unified search result, wherein each selectable user interface feature corresponds to one of the multiple service options.

18. The method of claim 17, wherein the multiple service options comprise a plurality of a rideshare option, a food delivery option, a food preparation option, a grocery delivery option, a freight transport option, a package delivery option, a prescription pickup and/or delivery option, a bikeshare option, a scooter-share option, or a transit connection option.

19. The method of claim 17, wherein the computing system to provides the search data to each of the multiple search engines in response to each alphanumeric character provided in the search box by the requesting user.

20. The method of claim 19, wherein the computing system obtains the search results from the multiple search engines and generate the unified search result for each inputted alphanumeric character provided in the search box.
